(19) United States
(12) Patent Application Publication
(10) Pub. No.: US 2006/0074881 A1
(43) Pub. Date: Apr. 6, 2006

(54) Structure independent searching in disparate databases

(75) Inventors: Sridhar Vembu, Palo Alto, CA (US); Radha Vembu, Chennai (IN); Santhana Krishnan Srinivasan, Chennai (IN)

Correspondence Address: Ashok Tankha;LIPTON WEINBERGER &HUSICK, 201 North Jackson Street, P.O. Box 934, Media, PA, 19063, US

(73) Assignee: AdventNet, Inc., Pleasanton, CA (US)

(21) Appl. No.: 10/957,341

(22) Filed: Oct. 2, 2004

(51) Int. Cl. G06F 17/30

(52) U.S. Cl. 707/3

(57) ABSTRACT

This invention allows keyword searches in both structured and unstructured databases, and across multiple databases of different vendors. An index database is created comprising word occurrences and table relationship information. In the case of unstructured databases with no predetermined schema, the relationship between different tables is derived through propagative n-level indexing and data is then populated in index tables. A database adapter enables indexing and searching across multi-vendor databases, which resolves discrepancies across different database access methodologies. Given a set of keyword inputs, the rows containing the search words and all the related rows are searched using word occurrences and relationship information.

### BACKGROUND OF THE INVENTION

This invention relates generally to database systems and in particular to conducting searches in structured, unstructured, single vendor and multi vendor databases.

A large part of data available on the web is hidden on dynamically generated sites in databases and standard search engines can not effectively access and index this data. This hidden mass of data is referred to as the “deep web”. It has been estimated that the deep web may contain approximately 500 times more information than the data that can be accessed directly in a database via search engines. Some websites provide a proprietary search interface, custom developed for their specific applications to access and retrieve data from the deep web in their databases.

Also, the target data in a database may not necessarily be stored in a single table. For example, the target data may be stored across multiple tables that are related through the keys of the tables. Complicating this problem further, there are many variations of databases available from different vendors. The common approach to searching databases is the use of structured query language (SQL) queries to fetch data from the databases. However, to use SQL queries, the user requires prior knowledge of the structure of data storage across tables and databases and their inter-relationships. The user also needs to be conversant with the arcane query languages.

Furthermore, in the case of legacy databases, the structural schema of the database, namely the keys of the tables and the relationship between the keys of different tables, is generally either unknown or is very poorly documented. In such cases, only the raw data of the database is available.

The current market solutions provide effective keyword based search solutions for the case of structured databases from a single vendor. However, there is an unsatisfied need to address the problem of keyword-based searches in unstructured databases of multiple vendors.

### SUMMARY OF THE INVENTION

This invention solves the above problems by providing keyword search functionality for a variety of database platforms. The database platform may include structured databases for which meta data definitions are available, or include unstructured databases for which no meta data information is available. The database platform may also comprise either a single database, or multiple databases from different vendors.

In this invention, an index database is created using a propagative n-level indexing method. The index database stores information regarding the occurrence of words, the relationship information between the keys of different tables, the primary key information of all the tables and the table rank information. Once the index database is created, it can be searched using multi-dimensional analysis.

Under this invention, a database adapter resolves the discrepancies when working across multi-vendor databases. The database adapter provides a consistent and uniform interface for conducting database operations.

The occurrence of a keyword in a table is indexed by storing the word, the column identifier that maps to the column name, table name and database name, and the number of times the given word occurs in the column. The relationship information indexed comprises the foreign key relationship between different tables, the primary key, and unique keys of each table. The relationship information is populated to facilitate data retrieval from the table containing the search words, and also data retrieval from across rows of other tables related to the search output.

For structured data, the population of relationship information is obtained directly from the schema and is a process well known in the art. However, this invention provides the ability to also search unstructured databases where no prior schema information is available by creating a relationship between different tables derived by propagative n-level indexing.

This invention also discloses a method to search across multiple tables. Given a set of keywords, the search engine fetches the actual rows from the database containing the given keywords. The keywords may be present in a single row of a table, or across rows in multiple tables. The search engine's in-built intelligence determines if the rows of different tables containing the keywords are related. Generally, data regarding a specific entity is not stored in a single table, but is split across different tables in a database. For example, consider the case where the contact number information of an employee is stored in the CONTACTINFO table and the remaining details of the employee like the name, age, department, etc., is stored in the EMPLOYEE table. The result is inadequate if the row containing the search keyword alone is given as the output. A more meaningful search result will comprise all the related rows from other tables. In the above case, when a phone number is given as the search input, the row containing the phone number from the CONTACTINFO table and the other details of the employee corresponding to this phone number from the EMPLOYEE table will be displayed in the output.

This invention also discloses a method to search across databases from different vendors through the use of a database adapter. The database adapter resolves the discrepancies across different database access methodologies and provides a consistent and uniform interface for conducting database operations.

This invention also discloses a method to determine the actual SQL queries for fetching data from different tables.

In addition to simplistic keyword-based searches, the invention can also support most of the standard SQL operations, for example, fetching a particular column based on a condition, ignoring a particular column from the search result, and determining the minimum, maximum and average values of a column. The keyword based search under this invention is performed through a user-friendly interface without the need for using complex SQL queries.

Other features of the present invention will become more fully apparent from the description below.

### BRIEF DESCRIPTIONS OF THE DRAWINGS

The above and further features of this invention can be understood by referring to the following drawings in conjunction with the accompanying description, in which like numerals indicate like structural elements and features in various figures.

FIG. 1 illustrates the process flow and architecture for the implementation of the search technique for structured databases, for unstructured databases, and across multiple databases of different vendors.

FIG. 2 illustrates the structure of the index tables.

FIG. 3A illustrates the process of indexing the database.

FIG. 3B illustrates the propagative n level indexing methodology.

FIG. 3C illustrates an example for the propagative n-level indexing method.

FIG. 3D1 displays an example of an employee table for describing the propagative n-level indexing method.

FIG. 3D2 displays an example of a department table for describing the propagative n-level indexing method.

FIG. 3E1 displays an example of a column index table for describing the propagative n-level indexing method.

FIG. 3E2 displays an example of a key info table for describing the propagative n-level indexing method.

FIG. 3F1 displays an example of word occurrences table for describing the propagative n-level indexing method.

FIG. 3F2 displays an example of relationship info table for describing the propagative n-level indexing method.

FIG. 3F3 displays an example of table weight table for describing the propagative n-level indexing method.

FIG. 4 illustrates the process of searching the database.

FIG. 5A illustrates the process and components in the database adapter.

FIG. 5B illustrates the query used in an example describing the database adapter.

FIG. 6 displays the user interface for the conducting the search.

FIG. 7 illustrates the table list in the search result.

FIG. 8 illustrates the search results and displays the data within each table.

FIG. 9.A illustrates the components of the Column Index Table.

FIG. 9.B displays the sample data for the Column Index Table.

FIG. 10.A illustrates the components of the Keyinfo Table.

FIG. 10.B displays the sample data for the Keyinfo Table.

FIG. 11.A illustrates the components of Word Occurrences Table.

FIG. 11.B displays the sample data for the Word Occurrences Table.

FIG. 12.A illustrate the components of the Table Weight Table.

FIG. 12.B displays the sample data for the Table Weight Table.

FIG. 13.A illustrates the components of the Relationshipinfo Table.

FIG. 13.B displays the sample data for the Relationshipinfo Table.

FIG. 14 illustrates the actual tables names and column names associated with the data given in FIG. 13B.

FIG. 15.A displays sample data for an Employee Table

FIG. 15.B displays sample data for an Address Table.

FIG. 16.A illustrates the structure of the Student Table.

FIG. 16.B illustrates the structure of the Final Year Student Table.

FIG. 16.C illustrates the structure of the Student Representative Table.

FIG. 17 displays the search results of an example of a search across multiple tables.

### DETAILED DESCRIPTION OF THE INVENTION

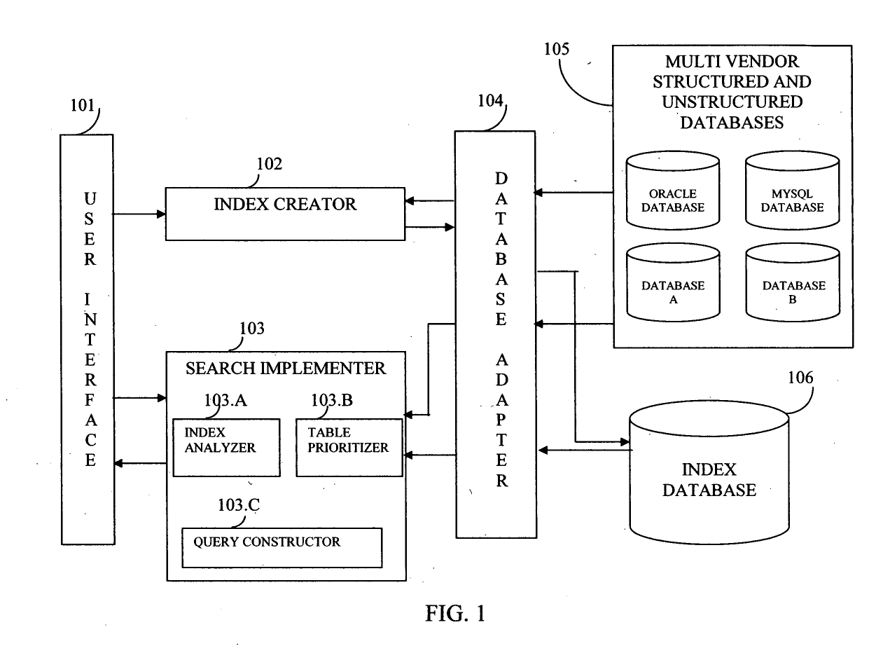

FIG. 1 illustrates the process flow and architecture for implementation of the indexing and search technique for structured databases, for unstructured databases, and across multiple databases of different vendors.

The index database 106 is first created. To create the index database 106, data is fetched from the multi-vendor structured or unstructured databases 105 through the database adapter 104. The index creator 102 builds the cross-indices for the multi vendor structured and unstructured databases 105. The index creator 102 derives word occurrences information, table weight information and table relationship information and thereafter populates the index database 106. The user inputs the keywords through the user interface 101. The search implementer 103 is pulled up on demand to provide relevant prescient search results for the given search words. The search implementer 103 consists of an index analyzer 103.A, table prioritizer 103.B and query constructor 103.C.

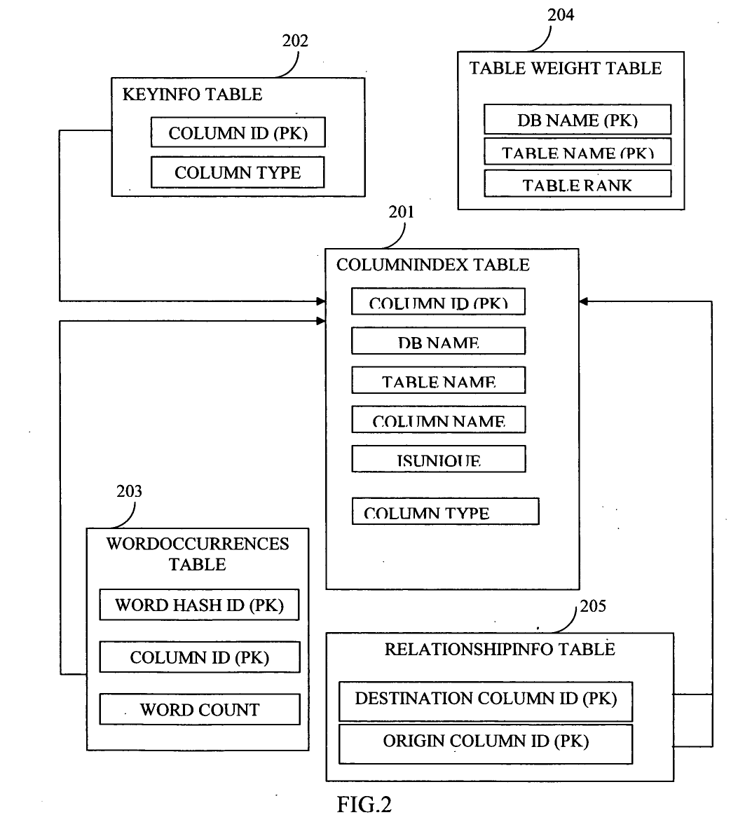

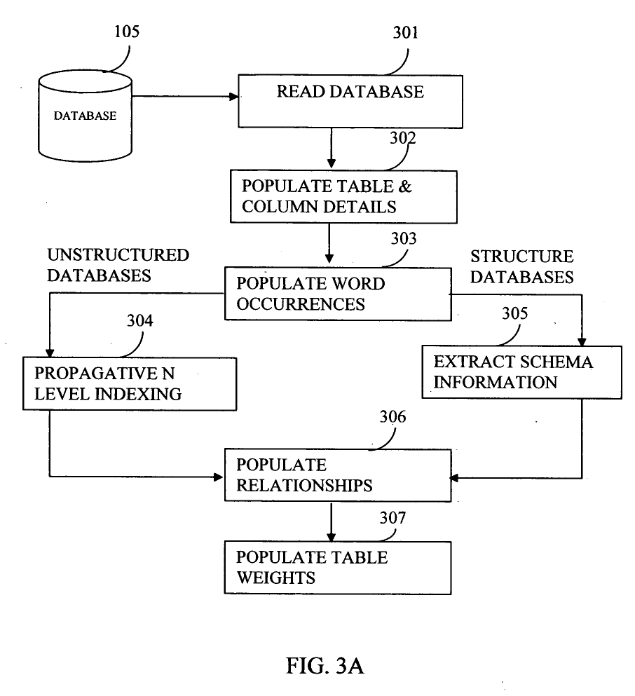

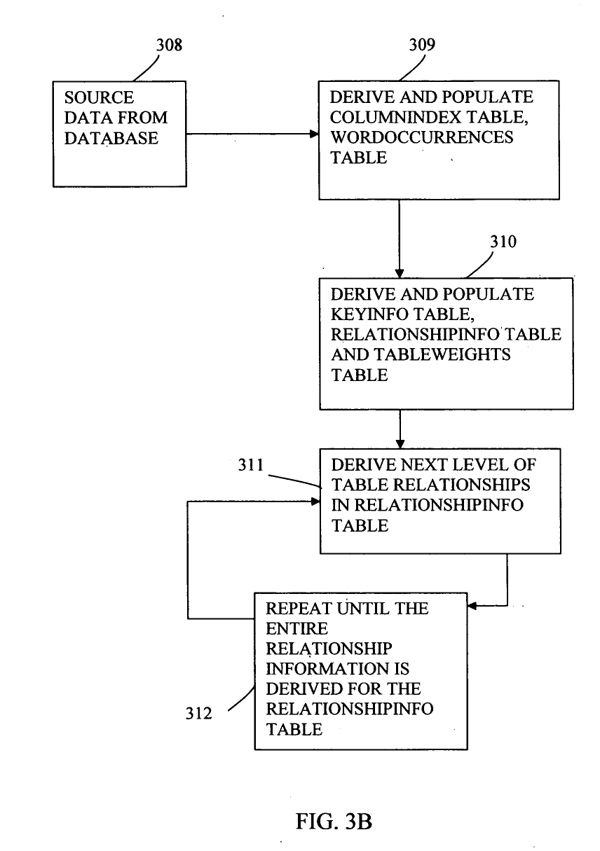

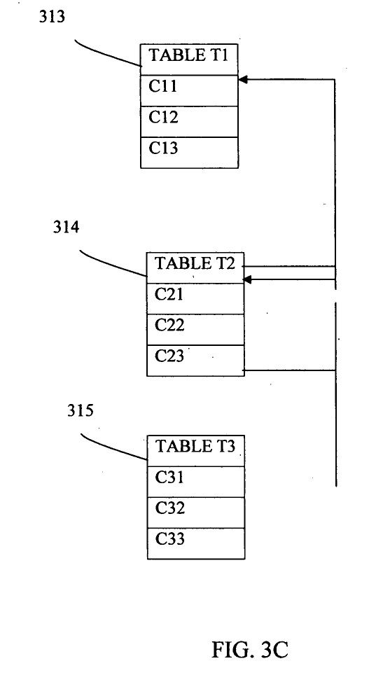

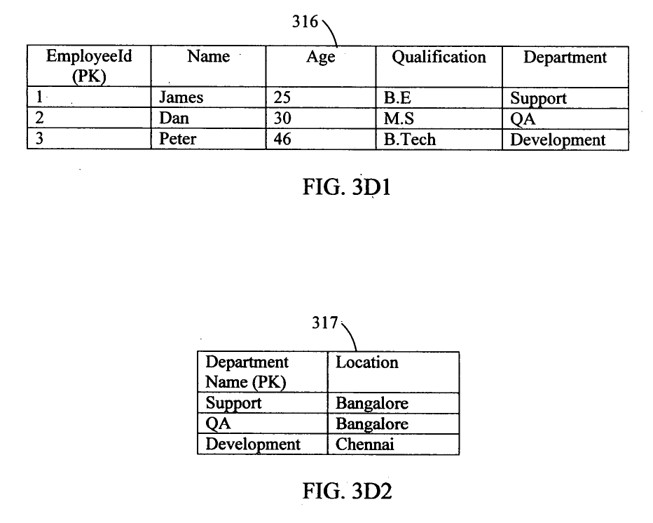

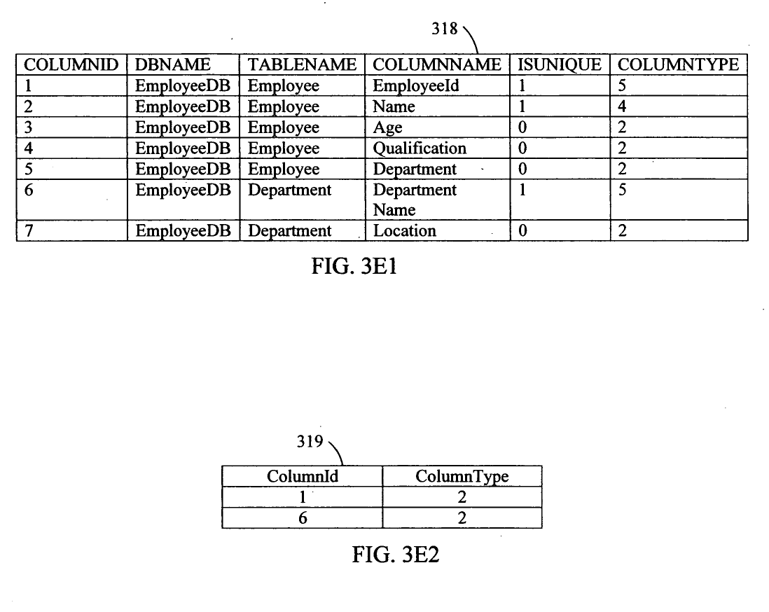

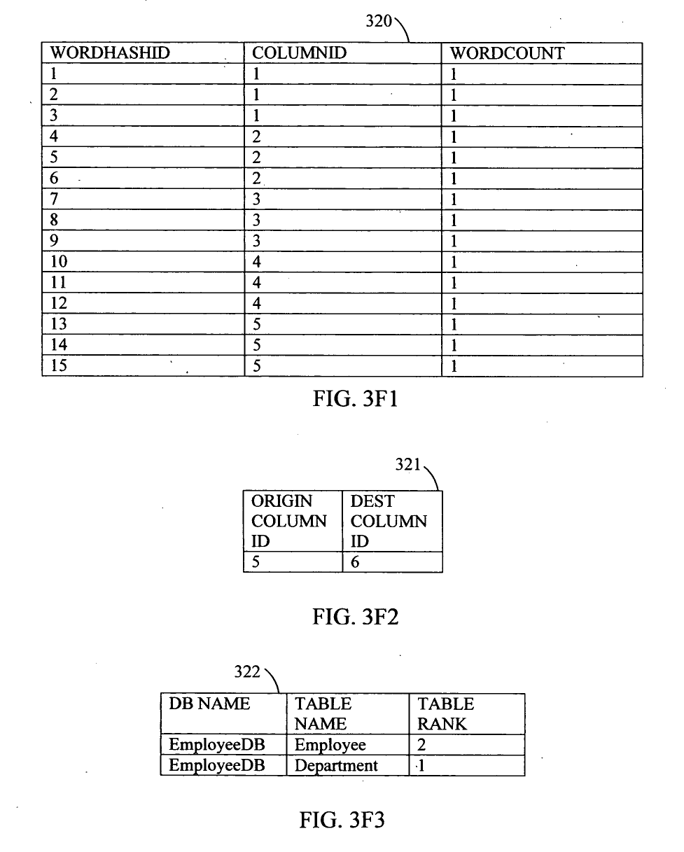

Propagative n-level indexing 304, illustrated in FIG. 3B, refers to the method of extracting word occurrences information and relationship information and creating an index database with the structure illustrated in FIG. 2. Data is sourced from the databases 308. The indexing process is propagative as it constructs the WORDOCCURRENCES table 203 and the COLUMNINDEX table 201 first shown in FIG. 3B, at 309, and then makes use of the information available in these tables to further construct the KEYINFO table 202, RELATIONSHIPINFO table 205 and TABLEWEIGHTS table 204 shown in FIG. 3B at 310. The RELATIONSHIPINFO table 205 is recursively populated as illustrated in steps 311 and 312 of FIG. 3B until all the table relationships are fully populated in the RELATIONSHIPINFO table 205.

The indexes store the relationship at one level and also extend it to n levels. FIG. 3C illustrates an example of the indexing method. For example, consider Tables T1 313, T2 314 and T3 315 which are related by foreign keys as follows:
T2.c21 is a foreign key (FK) to T1.c11, and T3.c31 is a FK to T2.c21. The relationship is populated as follows:
T2→T1 (level 1)
T3→T2 (level 1)
T3→T1 (level 2)
   Although there is no direct relationship between T3 and T1, the indexing methodology determines the intermediate relationships and builds the next level indexes.

FIG. 3A illustrates the process of indexing the databases. Data for populating the table and column details in 302, and data for populating the word occurrences details in 303 are derived from the read database 301. In the case of structured databases, the step of populating the relationships in 306 among the tables and the step of populating the table weights in 307 are performed using the extracted schema information in 305. In the case of unstructured databases, the above stated steps are performed using propagative n-level indexing 304.

FIG. 3D1 and FIG. 3D2 illustrate a sample database containing tables EMPLOYEE and DEPARTMENT respectively and FIG. 3E1, FIG. 3E2, FIG. 3F1, FIG. 3F2 and FIG. 3F3 exemplify how the index tables are populated using the propagative n-level indexing method. Consider an example of an employee table illustrated in FIG. 3D1 and a department table illustrated in FIG. 3D2. For each of the columns of the department table example 317 and employee table example 316, a unique column index table as shown by the rows of the table is created at 318, FIG. 3E1. The column index table example 318 includes the field's database name, table name and column name. The unique columns and the nature of each of the columns is derived and populated in the column index table example 318.

The key info table example 319 is illustrated in FIG. 3E2. From the set of unique columns, as provided by the column index table example 318, the primary key is selected based on the data type of the unique column, length of the column and number of columns forming the unique key. This information is populated in the key info table example 319.

The WORDOCCURRENCES table example 320 is illustrated in FIG. 3F1. For each of the columns of the department table example 317 and employee table example 316, the unique words of the columns are determined and the hashcode for each of the words is determined and populated in the WordOccurrences table example 320. For duplicate words in a column, the wordcount column value is updated.

Using the WordOccurrences table example table 320 for the words occurring in each of the primary key columns, the other unique columns referring to the words are determined. For example, the column id 6 (Department.DepartmentName) in FIG. 3E1 is a Primary Key (PK) column. Hence, the other unique columns that have the same words as the words of column id 6 are determined. The number of such columns that are identical is equal to the number of rows of the other table. This determination is used to populate the RelationshipInfo table example 321 illustrated in FIG. 3F2.

The TableWeight table example 322 is illustrated in FIG. 3F3. The number of tables pointing to a given table is determined using the RelationshipInfo table example 321. This obviates the need to execute the row count process for every search operation.

The populate word occurrences step involves tracking the occurrence of a word in all the columns, tables and databases. The relevant table name, column name, and database name in which the word resides is recorded. The number of times a given word occurs in a column of a table is also recorded. The word occurrences information is then populated in the WORDOCCURRENCES table 203.

The primary key and unique key information of all the tables is populated in the KEYINFO table 202 and COLUMNINDEX table 201. The relationship between the primary keys of different tables is populated in the RELATIONSHIPINFO table 205. The relationship between the primary key of one table and the foreign key of another table is also recorded in the RELATIONSHIPINFO table 205. The table rank is calculated based on the number of tables referring to the table under consideration.

The cell values are tokenized using delimiters. The tokenizing process helps in retrieving the relevant row with partial words as input, thereby avoiding the use of % word % query in the index database 106.

The search query is executed after the index information is populated in the index tables. Given a set of keywords to be searched, the search implementer 103, FIG. 1 finds the rows of tables that contain the search keywords, irrespective of whether the keywords are present in a single row of a table, or across rows of different tables. The data can also be fetched from multiple structured or unstructured databases 105 of different vendors. The actual queries that are executed in the multivendor structured and unstructured database 105 to fetch the data can be optionally provided with the search results. The results are ranked at the table level. The different rows within each table are also sorted based on different parameters.

The database neutrality across multi-vendor structured and unstructured databases 105 is achieved through the database adapter 104, FIG. 1. The structured or unstructured databases 105 may be provided by multiple vendors. For example, the structured or unstructured databases 105 may include commercial database products of Microsoft Corp., Oracle Co., or MySQL Inc. The interface of the database adapter 104 is used for all database operations such as create, retrieve, update and delete (CRUD). The database adapter 104 resolves the discrepancies between different databases 105, such as the difference in SQL syntax, data types supported by the different databases and features provided by different databases. The index creator 102 and the search implementer 103 use the database adapter 104 application programmer interface (API) for performing database operations. Thus the database adapter 104 acts as a database-neutral interface capable of handling multi-vendor structured and unstructured databases 105.

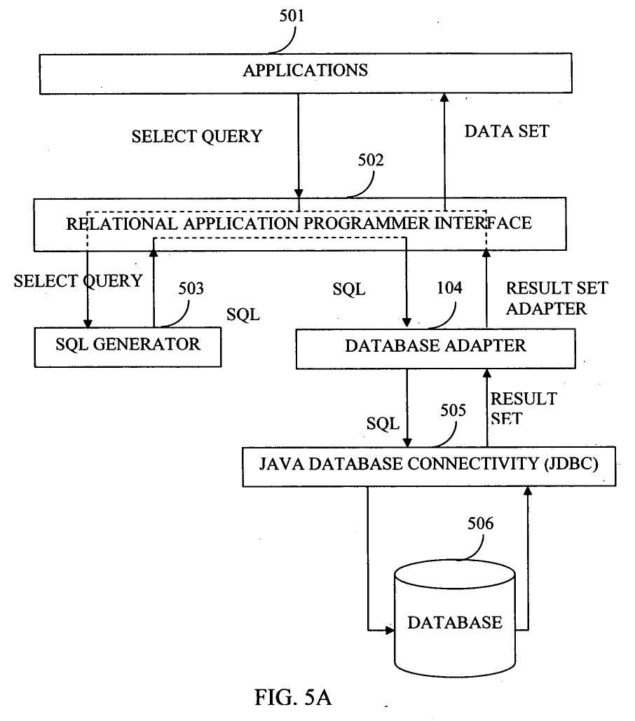

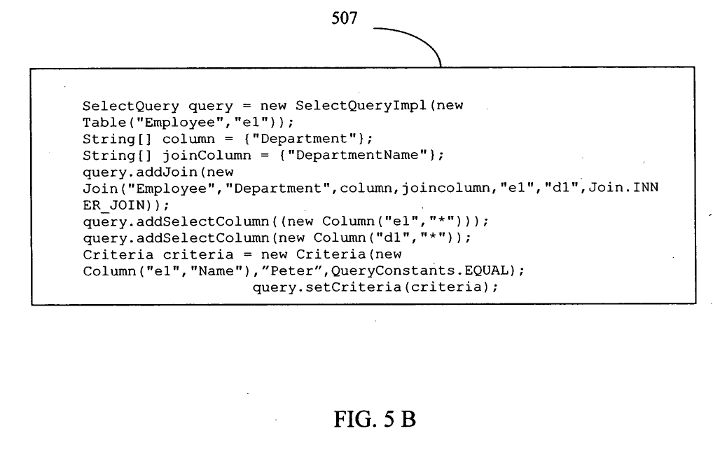

FIG. 5A illustrates the components of the database adapter 104 and the processes within the database adapter 104. The structured query language (SQL) generator 503 component generates database specific SQL Statements at run time. The database adapter 104 component executes the generated SQL statements and outputs the result that addresses Java Database Connectivity (JDBC) driver 505 inconsistencies. The database adapter 104 component acts as a single component that interacts with underlying databases 506. SQL Generator 503 component and database adapter 104 component are pluggable components. Separate implementation of the SQL Generator 503 and database adapter 104 will address the database inconsistencies.

Application 501 of FIG. 5A uses a database adapter 104 for SQL generation and execution. Relational Application Programmer Interface (API) 502 is a common API that communicates with the SQL Generator 503 and database adapter 104. The data manipulation and retrieval request is routed through the Relational API 502. The Relational API 502 uses the SQL Generator 503 and database adapter 104 to communicate with underlying databases 506. The SQLGenerator 503 generates database specific SQL statements as per the user input. The database adapter 104 executes the generated SQLs. The request from Relational API 502 is communicated through the database adapter 104 and JDBC driver 505 to the underlying database 506.

The SQLGenerator 503 generates SQL statements that retrieve records from the underlying database 506 matching the given criteria and with all the joins to be performed between tables. SQL statements are formed for the Data Manipulation Language (DML) write operations including insert, update, delete SQLs and Data Definition Language (DDL) operations including create table, drop table SQLs. The SQL statement (select, insert, update, delete, create table, drop table, etc.) is thereafter executed.

SelectQuery is the object structure of the American National Standards Institute (ANSI) 92 compliant SQL string. It comprises the following clauses: select clause, from clause, join clause, where clause, order by clause and group by clause. Each of the above clauses has an object representation. The SelectQuery object is the complete containment object.

DataSet is the wrapper class for ResultSet object that results from the execution of a SELECT statement. Dataset handles the ResultSet based inconsistencies and provides the uniform ResultSet-like interface for the applications.

The query executed by the system is captured in the SelectQuery object. The RelationalAPI 502 upon invocation uses appropriate database specific SQL Generator 503 to generate the DB-specific SQLs. The database specific SQLs are then executed using the database specific database adapter 104 and the ResultSet is wrapped in a ResultSetAdapter. The RelationalAPI 502 then converts the returned ResultSetAdapter into a DataSet that is used by the applications 501 to process the database search result.

The following example illustrates the use of the database adapter 104 of FIG. 1. Consider an example of a department table 317 illustrated in FIG. 3D2 and employee table 316 illustrated in FIG. 3D1. The query used to fetch the row corresponding to the name “Peter” from the employee table 316 and the corresponding row from the department table 317, is illustrated in FIG. 5B. Referring to FIG. 5B, the SelectQuery 507, Join, Column and Criteria are the database neutral objects provided by the RelationalAPI 502 of the database adapter 104.

Along with the selectquery object, the type of the data source will also be communicated to the RelationalAPI 502. The RelationalAPI 502 transfers the SelectQuery to the SQLGenerator of the corresponding database. The SQLGenerator 503 parses the SQL and generates the query corresponding to the database.

The output of the SQLGenerator 503 for the above SelectQuery object is as follows:
Select * from Employee, Department where Employee.Department=Department.DepartmentName and Employee.Name like ‘Peter’;

The database adapter 104 executes the query generated above on the underlying database 506 through JDBC driver 505. The database adapter 104 will return the result as DataSet objects. If a method against a data type is not supported for a particular driver, but the same is valid per JDBC 2.0 specifications, then the DataSet implementation for that driver and database will handle that specific situation.

The processes illustrated in FIG. 2 culminate in the creation of an index database 106. The structure of the index tables is illustrated in FIG. 2. The index database 106 consists of the following tables: COLUMNINDEX 201, KEYINFO 202, WORDOCCURRENCES 203, TABLEWEIGHT 204 and RELATIONSHIPINFO 205.

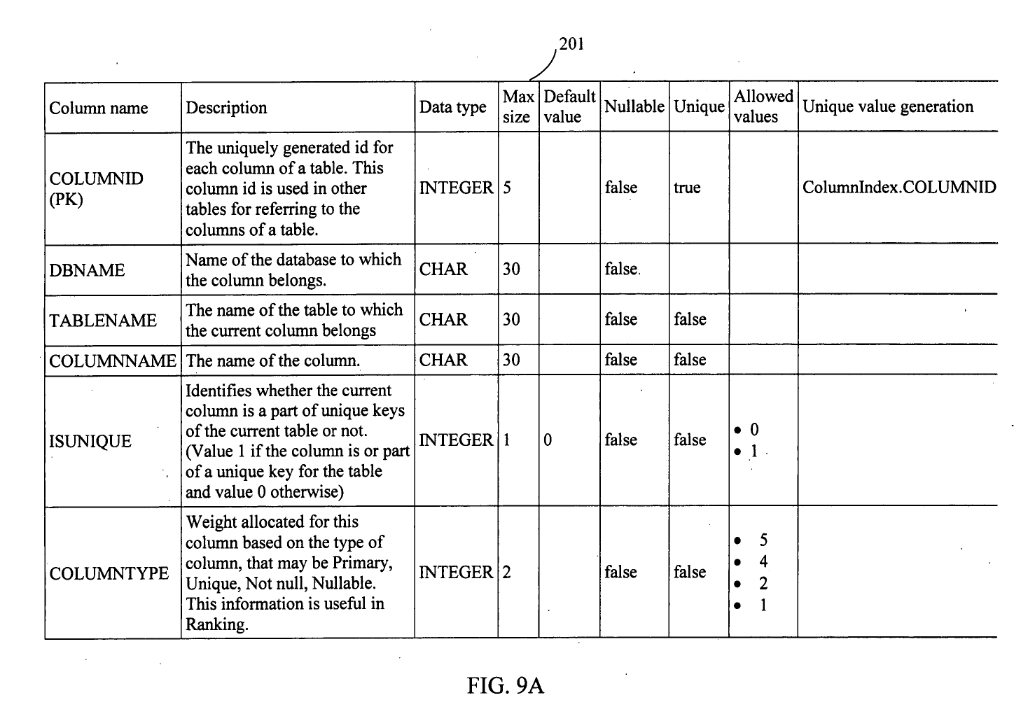

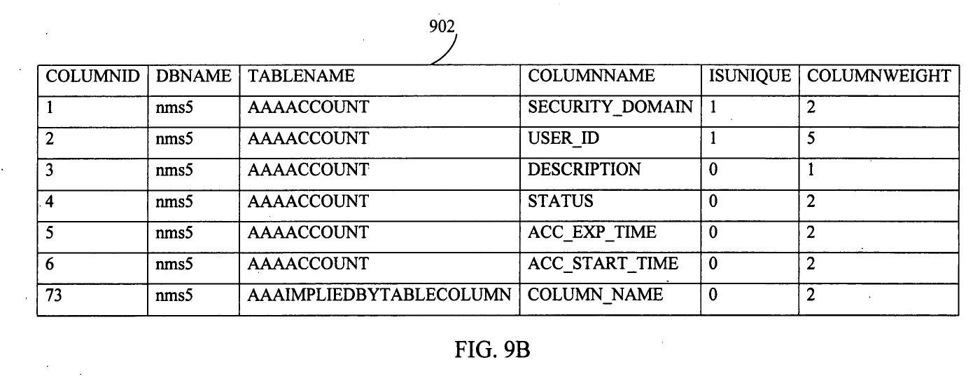

COLUMNINDEX table 201 is first created. A unique column identifier is assigned for the columns of all the tables in structured or unstructured databases 105. This unique column identifier is used in all the subsequent tables for referring to the columns of a table. COLUMNINDEX table 201 comprises information on whether the column is unique or not unique and whether it is a primary key column, or a foreign key column. The components of the COLUMNINDEX table 201 are described in FIG. 9.A.

In the case of structured databases, the uniqueness or non-uniqueness of a column is determined using the available schema information. For unstructured databases where no schema information is readily available, the data is analyzed using the propagative n-level indexing 304 method. The data analysis involves determining the number of distinct values of each column of a table and checking if the number is equal to the number of rows of the table. This process is continued for all possible column combinations, including the case where more than one column forms a composite unique key for a table.

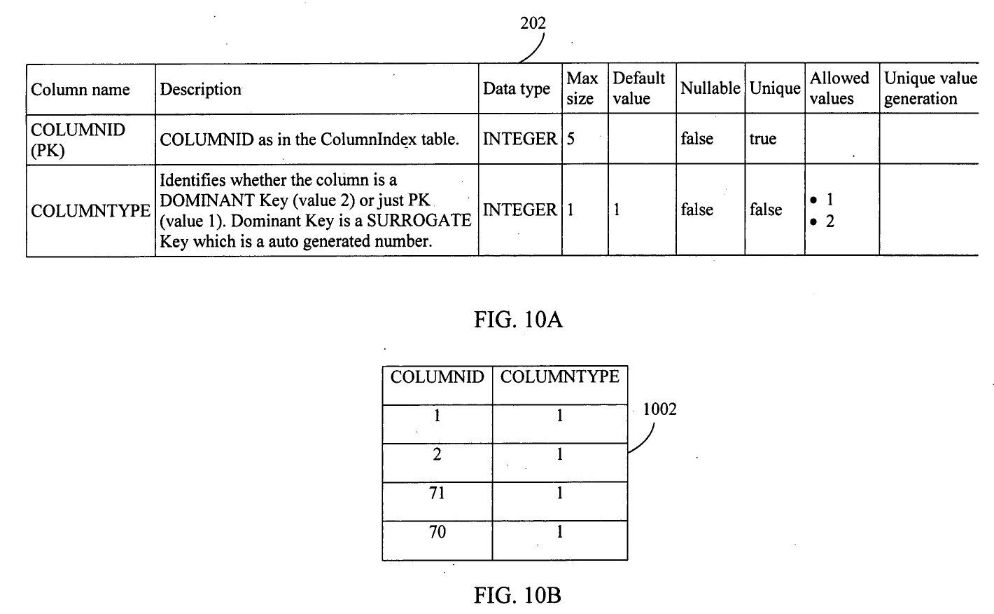

The next step in the indexing process is the population of the KEYINFO table. The KEYINFO table 202 stores information on the primary keys (PK) of the tables. It also stores information on whether the primary key of a given table is dependent on primary keys of other tables. For structured databases, the key information is populated directly using the schema information. For unstructured data, the most probable primary key is identified from the set of unique keys. This is achieved by applying heuristic algorithms on information comprising the number of column combinations forming the unique key, the data type of the column and the length of the data available in the column. The components of the KEYINFO table 202 are described in FIG. 10A.

Once the KEYINFO table 202 is populated, the next step is to index the occurrences of each word in the WORDOCCURRENCES table 203. It is not possible to trace the occurrence of each word by the row in which it occurs. Tracing the occurrence of the cell values with respect to the rows will result in a combinatorially unmanageable number of rows in the WORDOCCURRENCES table 203. If there are i tables each with j columns and k rows, there will be i*j*k rows resulting in the WORDOCCURRENCES table 203. This will significantly increase the size of the index tables, resulting in an increase in the look-up time for these tables. The performance of a search is directly dependent on the look-up time from these tables. Moreover, indexing with respect to the row may also result in duplicate information being stored in the index table. For example, if the allowed values of a column are TRUE/FALSE and if the table contains approximately 10,000 rows, then these two values will be repeated 10,000 times in the index table.

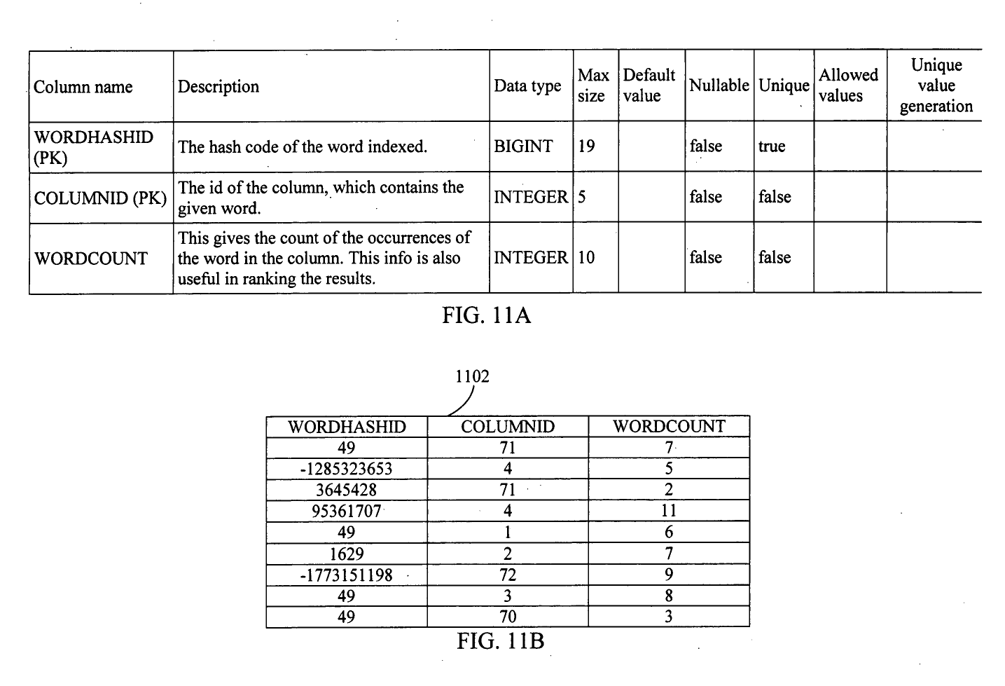

To avoid the above problem, the value of the cell is indexed with respect to the column of a table. In addition to tracking the occurrence of the word with respect to the table name and the column name, the WORDOCCURRENCES table 203 also keeps track of the number of times a word occurs in a given column. To populate the WORDOCCURRENCES table 203, all the tables of the input structured or unstructured databases 105 using the JDBC API are obtained. Thereafter, for each table, the columns and the distinct values of a column are obtained. Each of these cell values are tokenized using delimiters like space, ampersand, comma, dot and hyphen. The words are tokenized and indexed. For example, if a value in a particular cell is james@adventnet.com and if the search word is James, since the words are indexed after tokenizing, the row that contains james@adventnet.com will also be fetched. However, if the indexing is performed without tokenizing the cell values, then only rows containing an exact match on the keywords will be retrieved. For each of the tokens, the hash code value of the token is determined and the corresponding value is stored in the WORDOCCURRENCES table 203. The tokens are hashed in order to minimize the size of the index tables. The components of the WORDOCCURRENCES table 203 are described in FIG. 11.A.

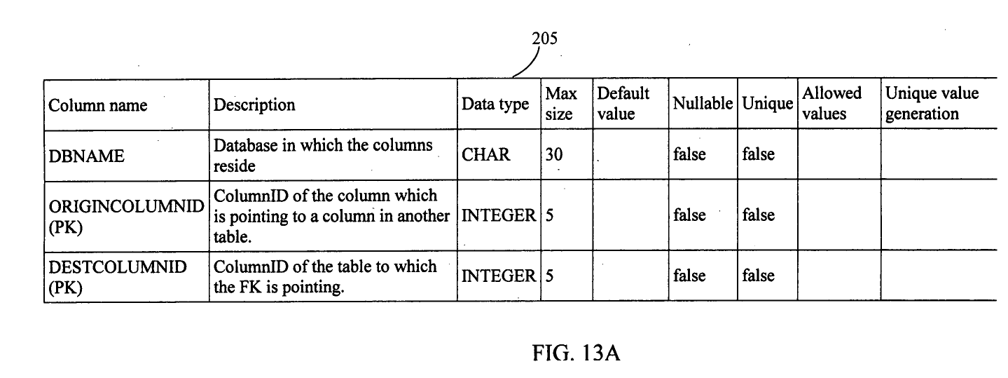

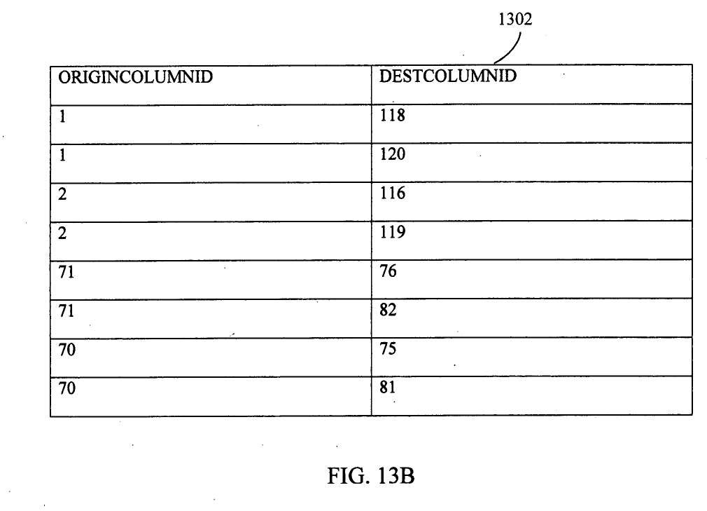

The RELATIONSHIPINFO table 205 stores the relationship between the keys of different tables. This relationship information is determined from the schema in the case of structured data. In the case of unstructured data, this information is derived based on the analysis of the data. The components of the RELATIONSHIPINFO table 205 are described in FIG. 13.A.

To determine the relationships between the different keys, the keys are first classified into two types. The first type of key is the surrogate key, which is a numeric key of length one. A single column forms the primary key of the table. The second type of key is the non-numeric key of length one or more. It can either be a single non-numeric column, or multiple column combinations forming the composite primary key. The second type of key will be referred to as a non-surrogate key hereafter. The classifications of the types of the keys are important, as the methodologies for determining the relationships between these two types of keys are significantly different. It is difficult to determine the relationship between tables that have surrogate keys, as sufficient information cannot be extracted from the numeric values of these columns to determine if two columns of different tables refer to each other.

For the non-surrogate case, the relationship between different keys is found using the information populated in the WORDOCCURRENCES table 203 through the following steps. The primary column of all the tables is obtained from the KEYINFO table 202. For each primary key column, the word occurring in the primary key column is identified, and the other unique column(s) in other tables that contain the same word are identified. Then a check is performed to determine if one of the tables is a subset of the other, i.e., the primary key (PK) and the foreign key (FK) are identified. This dependency information between keys is then populated in the RELATIONSHIPINFO table 205.

For example, consider the example of an EMPLOYEE table with primary key “EMPLOYEE.EmployeeName”. The following steps explain how the relationship between the keys is derived:
From the WORDOCCURRENCES table 203, find all the other unique columns referring to the words of the column “EMPLOYEE.EmployeeName”. Use the IsUnique field of the COLUMNINDEX table 201 to find the unique columns. Assume that the result of this step is “CUSTOMER.OwnerName” and “SPOUSEINFO.EmployeeName”.
Determine if “EMPLOYEE.EmployeeName” is a subset of “SPOUSEINFO.EmployeeName” or vice versa. If there is no subset identified, then these two columns are unrelated. If “SPOUSEINFO.EmployeeName” is contained in “EMPLOYEE.EmployeeName”, then “SPOUSEINFO.EmployeeName” refers to “EMPLOYEE.EmployeeName”. i.e., “SPOUSEINFO.EmployeeName” is a foreign key to the “EMPLOYEE.EmployeeName”. For the other case, “EMLOYEE.EmployeeName” contained in “SPOUSEINFO.EmployeeName”, “EMPLOYEE.EmployeeName” is a foreign key to “SPOUSEINFO.EmployeeName”.

The above information is populated in the RELATIONSHIPINFO table 205, FIG. 2. In order to determine the relation between surrogate keys, the set of tables that contain surrogate keys are identified and the relation between surrogate keys is determined. The steps involved in identifying the set of tables that contain surrogate keys are described below. Check if the number of columns forming the primary key of the given table is one. Check if the data type of the primary key column is an INTEGER. Determine if the column values are sequential. Provide an allowance for deviation, as there is a possibility for missing key values in cases where rows have been deleted. Perform a similar analysis for the keys of all the tables and determine the list of surrogate keys. The steps involved in determining if two surrogate keys are related are described below. Determine if any two tables have exactly the same key values. If the two tables have exactly the same value, the two keys are related. Determine if any one of the keys is a subset of the other. Determine if the subset covers the whole range. For example, if one key value range is 1 to 1000 and another key value range is from 1 to 50, then it is not possible to conclude that one key is related to the other. Based on the above analysis, the RELATIONSHIPINFO table 205 is populated.

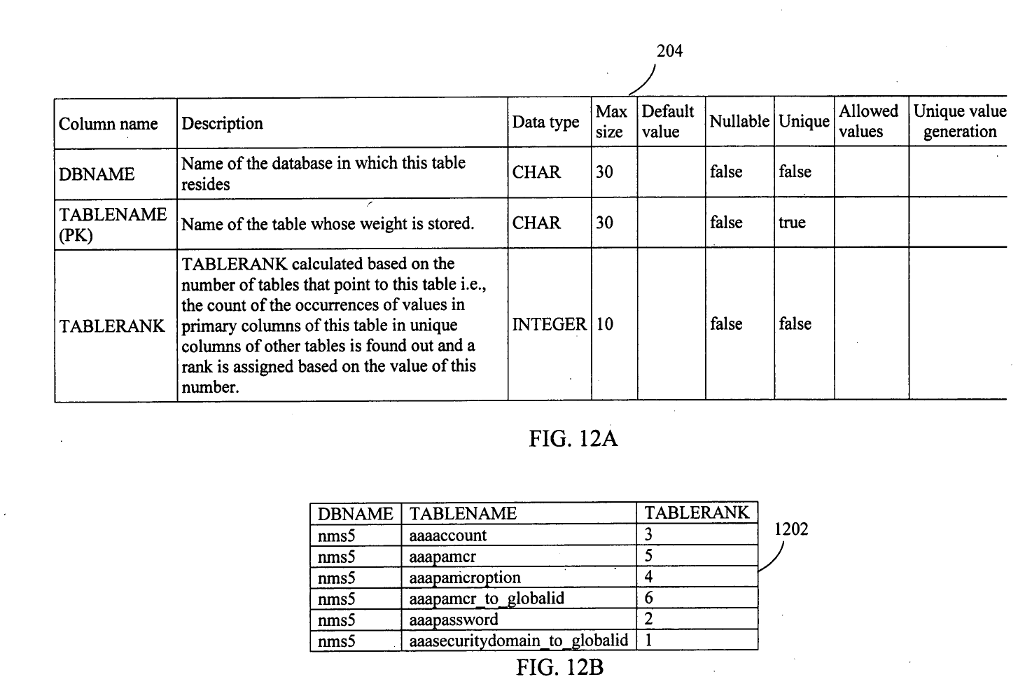

The TABLEWEIGHT table 204 maintains the TableRank of a given table. TableRank is calculated based on the number of tables that refers to the table under consideration. TableRank indicates the level of importance of the given table during the search process. If a large number of tables have a foreign key (FK) relationship with the given table, then the level of importance of the table is high. The number of tables pointing to the current table is calculated from the index information in WORDOCCURRENCES table 203. Table Rank is the count of the occurrences of values in primary columns of the given table in unique columns of other tables. The components of the TABLEWEIGHT table 204 are described in FIG. 12.A.

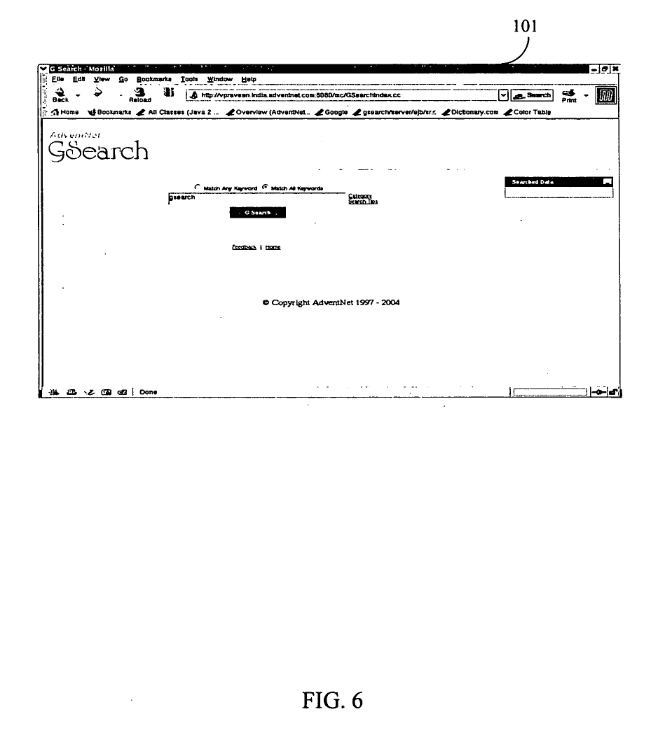

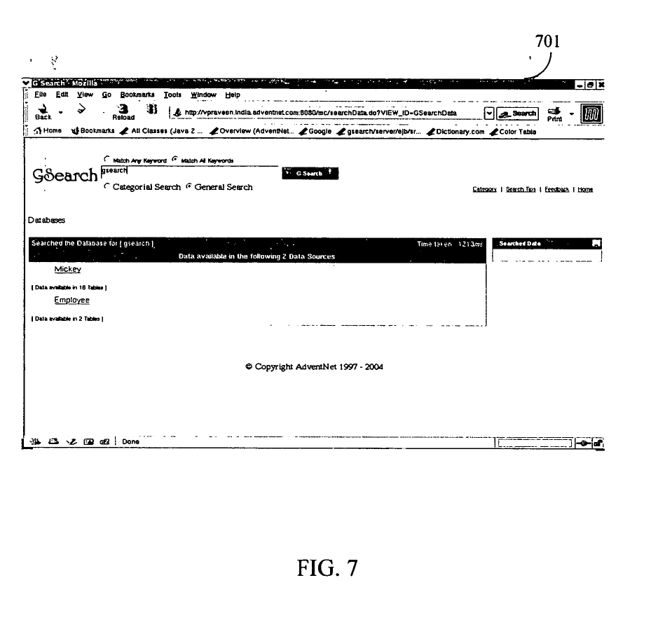

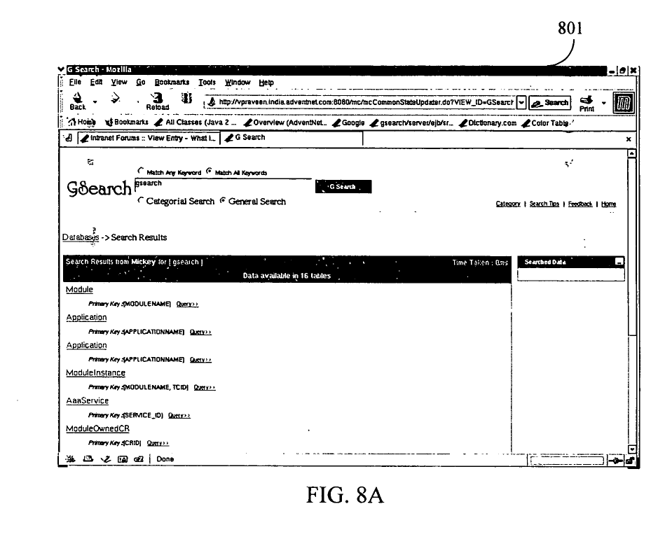

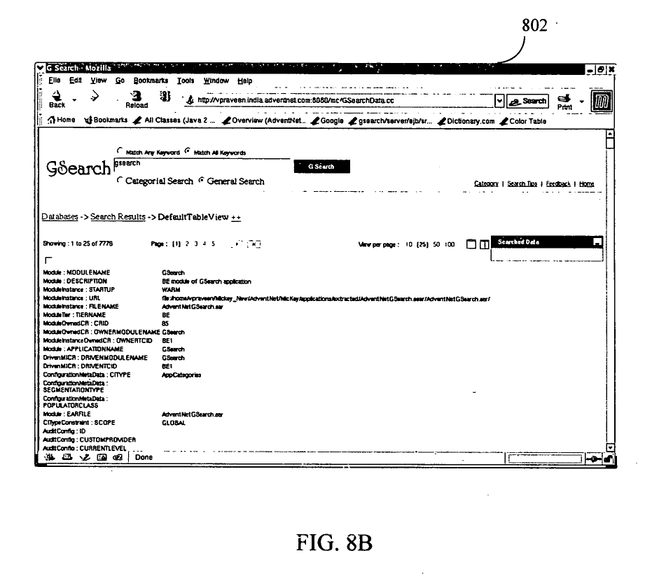

The search process consists of the step of searching the given words in a single table, followed by the step of searching the given set of words across different tables that are related through a primary key. The steps involved in the searching process once the search words 401 are input through the search interface 601 are determining the occurrences of word 402 in the tables, prioritizing the tables identified 403, checking table 404 to determine if it contains all the search words, finding the related tables 405, forming the join between the tables 406, constructing the query for the related tables 407, and executing and displaying the results 408. The user interface 101 is illustrated in FIG. 6. FIG. 7 illustrates the output of the search 701 in the form of a list of databases that contains the input word and FIG. 8A illustrates the output of the selected database as a list of tables 801. FIG. 8B further illustrates the search results, with the data displayed within each table 802.

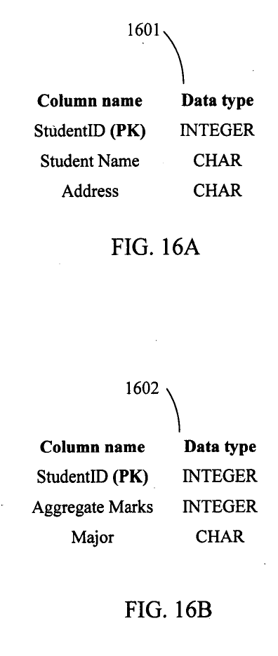

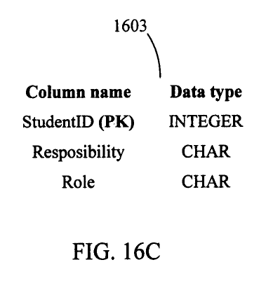

This invention not only fetches data from the table that contains the search words but also fetches information from other related tables. For example, consider the tables STUDENT 1601 illustrated in FIG. 16A, FINALYEARSTUDENT 1602 illustrated in FIG. 16B and STUDENTREPRESENTATIVE 1603 illustrated in FIG. 16C.

Assume that all the Students of a college have entries in the STUDENT table 1601 and the final year students have some additional information stored in the FINALYEARSTUDENT table 1602 in addition to the STUDENT table 1601. Similarly, assume that only final year students can become a student representative. Therefore, a student representative will have entries in STUDENT, FIG. 16.A, FINALYEARSTUDENT, FIG. 16.B and STUDENTREPRESENTATIVE, FIG. 16.C. If the tables are searched using the student name as input, the output will contain data from one, two or all of the tables depending on whether he or she is a student, a final year student, or a student representative respectively. The current invention uses the relationship between the keys of different tables to fetch data. This method of using the Primary Key (PK) and Foreign Key (FK) relationships between the tables to intelligently fetch all the relevant information is called a multi-dimensional search.

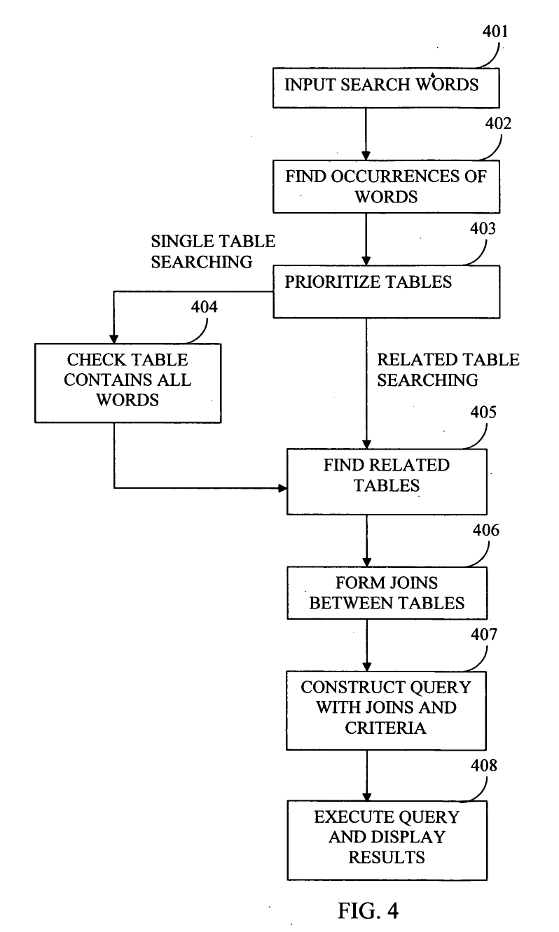

The steps involved in multi-dimensional searching for a given set of input words are described below:
Tokenize the words based on the delimiters as multiple tokens. The word structures used in the tokenizing and indexing procedures are similar. For example, if radha@adventnet.com is the word, then it will be split as radha, adventnet, corn in the tokenizing procedure. The indexing process follows a similar procedure.
Derive the occurrences of these words from the WORDOCCURRENCES table 203.
Identify the table name and the column name for each word occurrence using the ColumnId in the WORDOCCURRENCES table 203.
Generate a list of tablename.columnname for each of the words.
Calculate the table weights for each of the tables identified in the prior step. The table weight is calculated using COLUMNINDEX.ColumnType, WORDOCCURRENCES.WordCount and TABLEWEIGHT.TableRank.
Conduct a check operation to ensure all the search words are present in the tables 404 illustrated in FIG. 4. Find the intersection of table names that contains all the search words. As an example, consider the inputs words w1 and w2 and tables T1, T2, T3, T4, T5 and T6. Assume that w1 is present in T1, T2, T3, T4 and w2 is present in T1, T4, T5, and T6. It can be inferred that the intersection of tables namely, T1 and T4 contains both the words w1 and w2.
For each one of the tables, find the related tables 405 from the RELATIONSHIPINFO table 205.
For each one of the related tables 405, form a join query 407 to fetch data from the main row and the related row.
Form criteria using the column name and the given word to retrieve the actual data from the table. For example, assume that the input words are adventnet and snmp, and adventnet occurs in COMPANY.CompanyName, SUPPORT.Organization and snmp occurs in COMPANY.ProductName and SUPPORT.Subject. The criteria for this example will be formed as follows:
Select * from company where COMPANY.CompanyName=‘adventnet’ and COMPANY.ProductName=‘snmp’
Select * from support where SUPPORT.Organization=‘adventnet’ and SUPPORT.Subject=‘snmp’
Form the join condition 406 for the above query using the column name mapping available in the RELATIONSHIPINFO table 205.
Execute the join query 407 and fetch the data from the main table that contains the search words and also the related rows from other tables. It is important to note that only this step is performed in the main structured or unstructured databases 105. All the other steps are performed on the freshly created index database 106.

Thus, the search result will provide the rows containing the search words, and also all the related rows from other tables that are linked by the keys. This method is particularly effective when the data is split in multiple tables for normalization purposes. The present invention thereby exploits the relationships between tables to fetch relevant data from multiple tables.

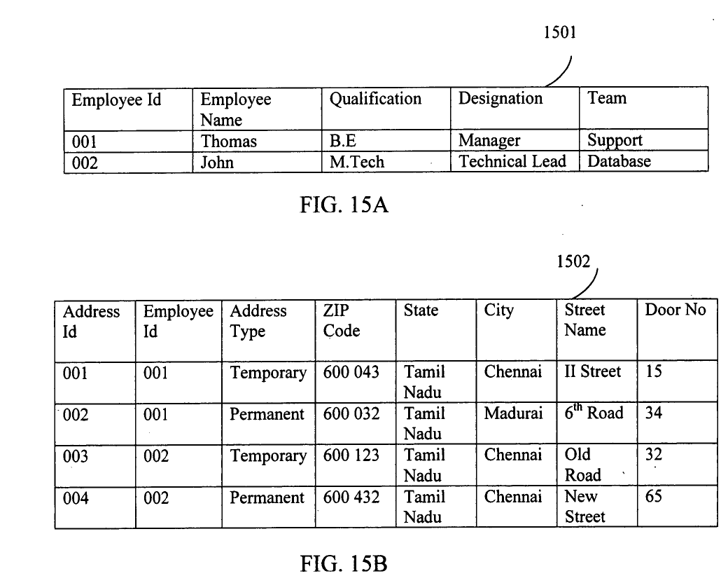

It is not necessary for all the keywords to be present in a single table. Data can be spread across different tables that are linked by a primary key or a foreign key. For example, consider the details of an employee illustratrated in FIG. 15A. Employee details such as age, qualification, years of experience, designation, etc., is present in the EMPLOYEE table 1501, FIG. 15A. Information such as the address of the employee is available in the ADDRESS table 1502 illustrated in FIG. 15B. Consider the case of using the search words “John, Chennai”. The search result should contain rows of data that contain the entire set of the given search words. But in the above example, a single row of a table does not contain all the search words. In such cases, data needs to be fetched from rows of different tables provided the rows of different tables are related by the primary key or foreign key relationships. The search tool fetches information of all the employees with EMPLOYEE.Name as “John” and ADDRESS.City as “Chennai”. The Name column of the EMPLOYEE table contains the search word “John” and the City column of the ADDRESS table contains the search word “Chennai”.

The method of searching across multiple tables is now described. Consider an example where the search input is w1, w2, and w3. Assume that w1 is present in table T1.r1 and w2, w3 are present in table T2.r2. Assume that the rows r1 and r2 are related by the same primary key value. The following process steps find the tables T1, T2 as the search result for the given inputs w1, w2, w3:
1. Find all the columns that contain at least one of the input words. Follow steps 1, 2 and 3 of the method used for searching in the same table. Assume the given words are w1, w2, and w3.
2. From the list of tables for each word, select the union list. L1 is the list of tables for w1 and similarly L2 and L3 for w2 and w3 respectively. Assume that the union list is Lu.
3. For each of the tables in the union list, find all the related tables using the information available in the RELATIONSHIPINFO table 205. Assume that the related tables list as Lr.
4. Form the intersection lists for each word, i.e., w1=Lr intersection L1 w2=Lr intersection L2 and w3=Lr intersection L3
5. Form the join query 406 for all the combination of tables identified from the intersection using the column name and the search word as criteria and the join condition formed using the column names available in the RELATIONSHIPINFO table 205.
6. Repeat this procedure for all the tables of the list. Rank the results based on relevancy.

The search is conducted through a user-friendly keyword search user interface 101. The user does not need to have prior knowledge of the underlying database structure or need to be conversant with SQL software language to retrieve data from the structured or unstructured databases 105. This user interface 101 performs functions offered by SQL, for example:
viewing all rows of a given table
viewing all rows of a given column
viewing all rows of a given tables except some columns
searching a word in a given set of tables and columns
search with some criteria where the relational operators supported by the criteria are =, >, <, <=, >=, !=
and the logical operators supported are and, or
and the sql operators supported are like, between, not like, in, not in.

For the given set of search keywords, the output can be viewed in two formats. One format displays the actual data fetched from the index database 106 and the other format displays the queries that are used to fetch the data. The query generated is specific to the type of the database containing the data.

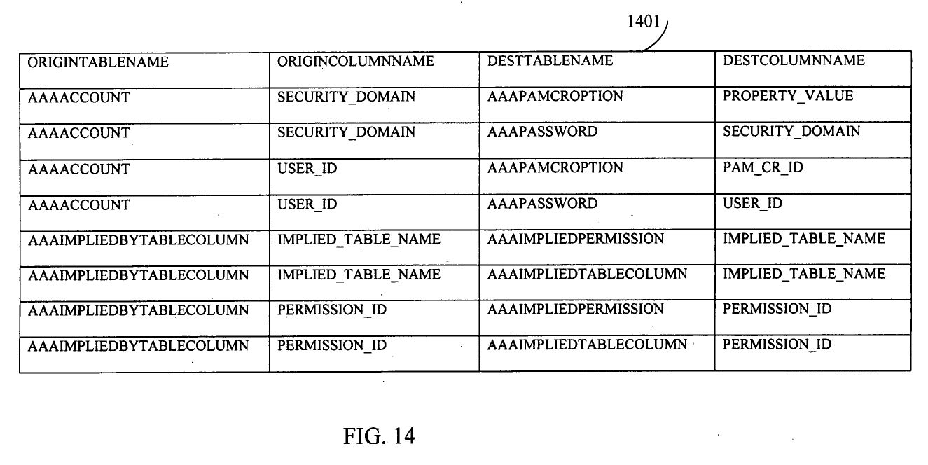

FIG. 9B, FIG. 10B, FIG. 11B, FIG. 12B, FIG. 13B illustrate an example of the indexing and searching method in a single table. Assume that the search words are adventnet, gsearch. The indexing and searching process is explained below:
Find the hashcode of the given words using the java hashcode API, say, adventnet=49 and gsearch=3645428
Fetch the data for these WordHashIds from the WORDOCCURRENCES table example 1102 in FIG. 11B.
From the above table it is inferred that the word adventnet (=49) occurs in ColumnIds 71, 1, 3, 70 and word gsearch (=3645428) occurs in ColumnId 72
From the COLUMNINDEX table 902 in FIG. 9B, determine the TableName, ColumnName corresponding to each of the ColumnIds.
1—AAAACCOUNT.Security_Domain
3—AAAACCOUNT.Description
70—AAAIMPLIEDBYTABLECOLUMN. Permission_Id
71—AAAIMPLIEDBYTABLECOLUMN. Implied_Table_Name
72—AAAIMPLIEDBYTABLECOLUMN. Implied_By_Table_Name
The keyinfo table 1002 contents are illustrated in FIG. 10B.
Calculate the table ranks for each of the tables.
AAAACCOUNT—9
AAAIMPLIEDBYTABLECOLUMN—6
Rank=(sum of WordCount in each table)/TableRank+(sum of ColumnType in each table). For example, for AAAACCOUNT, Rank=((6+8)/2)+2=9. FIG. 12.B displays the sample data for the Table Weight Table 1202.
Process the tables based on their Ranks and check if all the words are present in the given table. For example, AAAACCOUNT contains only the word adventnet, whereas AAAIMPLIEDBYTABLECOLUMN contains both adventnet and gsearch. In that case, consider only the table AAAIMPLIEDBYTABLECOLUMN for further processing. Fetch the related tables for AAAIMPLIEDBYTABLECOLUMN from RELATIONSHIPINFO table example 1302 in FIG. 13B. The actual table names and column names of the RELATIONSHIPINFO table example are listed in table 1401 of FIG. 14.
The related tables of AAAIMPLIEDBYTABLECOLUMN are AAAIMPLIEDPERMISSION and AAAIMPLIEDTABLECOLUMN
Form a join query that will fetch data from <AAAIMPLIEDBYTABLECOLUMN, AAAIMPLIEDPERMISSION> and <AAAIMPLIEDBYTABLECOLUMN, AAAIMPLIEDTABLECOLUMN> where the criteria is AAAIMPLIEDBYTABLECOLUMN. Implied_Table_Name=‘adventnet’ and AAAIMPLIEDBYTABLECOLUMN. Implied_By_Table_Name=‘gsearch’
The join condition to fetch data from table's AAAIMPLIEDBYTABLECOLUMN, AAAIMPLIEDPERMISSION is
AAAIMPLIEDBYTABLECOLUMN_Table_Name=AAAIMPLIEDPERMISSION.Implied_Table_Name and
AAAIMPLIEDBYTABLECOLUMN.Permission_Id=AAAIMPLIEDPERMISSION.Permission_Id
Similarly the join condition to fetch data from AAAIMPLIEDBYTABLECOLUMN, AAAIMPLIEDTABLECOLUMN is
AAAIMPLIEDBYTABLECOLUMN.Implied_Table_Name=AAAIMPLIEDTABLECOLUMN.Implied_Table_Name
AAAIMPLIEDBYTABLECOLUMN.Permission_Id=AAAIMPLIEDTABLECOLUMN.Permission_Id

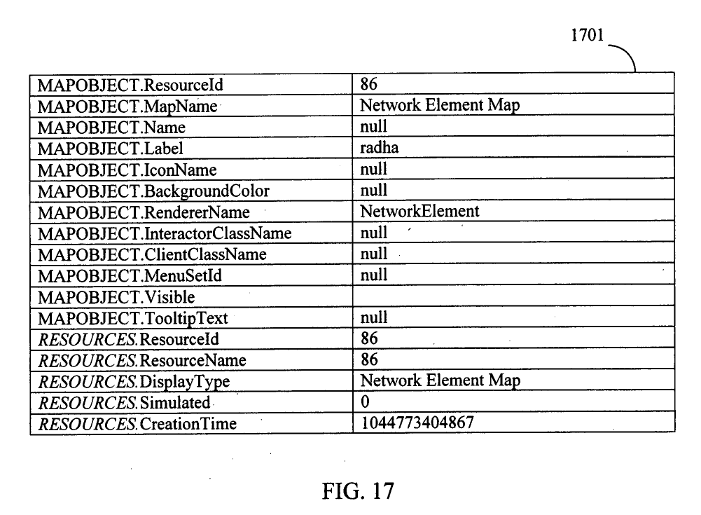

An example of the search methodology across multiple tables is described below. Assume the input words to be Radha and NetworkElement.
Compute the Hash value of the input words using the hashcode API, say, Radha=50 and NetworkElement=100.
From the WORDOCCURRENCES table 203, FIG. 2 find the list of ColumnIds containing the input words, i.e., the ColumnId corresponding to the WordHashId 50 and 100.
From the ColumnId find the table names, column names using the COLUMNINDEX table 201
Prioritize the list of tables according to the table rank calculated for each of the tables using the data available in the TABLEWEIGHT table 204.
The output at the end of this step is:
Radha=[MAPOBJECT, WORDLIST, NETWORKELEMENT]
NetworkElement=[JOINTABLE, RESOURCES, MAPOBJECT, WORDLIST, RESOURCES_PIDX]
The left hand side of the above equation is the search words and the right hand side is the names of the tables containing the input words.
Form the union list of the tables for each of the words. The union list is:
Union List [MAPOBJECT, WORDLIST, NETWORKELEMENT, JOINTABLE, RESOURCES, RESOURCES_PIDX]
For each of the tables in the union list, find the related tables from the RELATIONSHIPINFO table 205.
Process tables from UnionList: MAPOBJECT
Related tables: [ADDRESS, RESOURCES, MAPOBJECT]
Find the intersection of the related list of tables with the list of tables for each of the words.
Intersection: {Radha=[MAPOBJECT], NetworkElement=[RESOURCES, MAPOBJECT]}
Now form all possible combinations with the list of tables for each word.
JOIN PAIRS [MAPOBJECT, RESOURCES], [MAPOBJECT, MAPOBJECT]
select * from MAPOBJECT, RESOURCES where (MAPOBJECT.Label like ‘% radha %’) and (MAPOBJECT.RendererName like ‘% networkelement %’ or
RESOURCES.DisplayType like ‘% networkelement %’) and MAPOBJECT.Resourceld=RESOURCES.Resourceld
select * from MAPOBJECT where (MAPOBJECT.Label like ‘% radha %’) and
(MAPOBJECT.RendererName like ‘% networkelement %’)
From the above join queries the second query will be filtered out as it is covered by the words in the same table. Hence, only the first query is executed and the output is shown.
The result 1701 of the following query is illustrated in FIG. 17.
select * from MAPOBJECT, RESOURCES where (MAPOBJECT.Label like ‘% radha %’) and (MAPOBJECT.RendererName like ‘% networkelement %’ or
RESOURCES.DisplayType like ‘% networkelement %’) and MAPOBJECT.Resourceld=RESOURCES.Resourceld.

Similarly the other tables of the Union List namely, WORDLIST, NETWORKELEMENT, JOINTABLE, RESOURCES, RESOURCES_PIDX are processed.

For a given search query, the results are extracted from different tables that contain the given input words. The method of ranking the search results is hereafter discussed. The results are ranked based on the TABLE WEIGHT value. The COLUMNINDEX.ColumnType, WORDOCCURRENCES.WordCount and the TABLEWEIGHT.TableRank determine the table weight. The value of COLUMNINDEX.ColumnType depends on whether the given column is a primary key column or unique key column or foreign key column. The Tables are ranked as follows:
Determine the table weight and number of rows for the list of tables obtained from TABLEWEIGHT table 204.
Determine the column weight from the COLUMNINDEX table 201 for the list of columnids obtained.
Determine the number of occurrences of word in a column from WORDOCCURRENCES table 203.
Calculate WordDensity, which is the ratio of the number of occurrences of a word in a given table to the number of columns and rows in the table.
Calculate the Term Weight for the search words, which is derived from the ratio of the number occurrence of the word in the given database to the number of occurrence in the given table.
Calculate table rank, which is a function of column weight, table weight, word density and term weight.
Prioritize the tables based on the table ranks.
After the tables are ranked, the different rows of a table are sorted based on different parameters that can be selected from the client interface.

While the above description contains much specificity, it should not be construed as limitations on the scope of the present invention, but rather as an exemplification of one preferred embodiment thereof. Many other variations are possible. Accordingly the scope of the present invention should be determined not by the embodiment (s) illustrated, but by the appended claims and their legal equivalents.

We claim:

1. A method of conducting keyword searches in databases, comprising the steps of:
creating an index database of word occurrences information and relationship information by extracting said word occurrences information and relationship information through an existing schema from structured databases and through propagative n-level indexing of unstructured databases for which no predetermined schema is available;
providing a database adapter for enabling indexing and searching across multi-vendor structured and unstructured databases and supporting database specific operations of new database systems, removing structured query language inconsistencies, removing java database connectivity driver related inconsistencies and removing database vendor specific inconsistencies;
determining the occurrences information of said keywords and determining the relationship information for the keywords from said index database;
forming a query with joins for fetching the rows of the database containing the keywords using the word occurrences information and relationship information, wherein said rows are of multiple tables that are related by keys, or are of a single table; and
retrieving the results from the database and prioritizing the results based on the importance of the tables using table ranks.

2. The method of claim 1 wherein the step of extracting word occurrences information comprises the steps of:
extracting the database name, table name and column name in which a word occurs; and
determining the count of occurrence of the word in a given column.

3. The method of claim 1 wherein the step of extracting the relationship information through an existing schema from structured databases is performed by deriving metadata application programming interface of java database connectivity of the structured databases.

4. The method of claim 1 wherein the step of extracting the relationship information through an existing schema from structured databases comprises the steps of:
extracting primary key information;
extracting unique key information of different tables of the database;
extracting the foreign key information of different tables of the database;
extracting the relationship between keys of different tables using java database connectivity application programmer interface; and
extracting information on table marks for each table, wherein said table marks are calculated by determining the number of other tables that point to said table.

5. The method of claim 1, wherein the step of extracting said word occurrences information and relationship information by propagative n-level indexing of unstructured databases, comprises the steps of:
identifying unique keys of each of the tables in the database by determining all the unique column combinations;
identifying the primary key of each of said tables from a set of said unique keys;
identifying the relationship between the keys of different-tables, further comprising the steps of:
determining like relationship between the primary keys of different tables; and
determining the relationship between the foreign key of a table and the primary key of another table using the word occurrences information, whereby the method of using the word occurrences information precludes the need to search all the columns of all the tables of the unstructured databases.

6. The method of claim 1, wherein the step of searching the databases comprises the steps of:
fetching word occurrences of the keyword;
fetching the relationship information from the index database; and
utilizing the word occurrences information and the relationship information for determining a list of tables and the corresponding columns in the tables that contains the keywords.

7. The method of claim 6, wherein determining a list of tables further comprises the step of selecting or dropping a table, the step of selecting or dropping a table comprising the steps of:
selecting a table, or list of multiple tables when the keywords are present either in a single table or distributed across multiple tables; and
dropping a table even if one of the keyword is not present in the table and its related tables.

8. The method of claim 1, wherein said database is either from a single vendor or from multiple vendors.

9. The method of claim 1, wherein the step of providing a database adapter further comprises:
providing a uniform, database neutral application programmer interface for input to the database adapter; and
deriving an output as a uniform wrapper of a result set independent of the nature of the underlying database used.

10. The method of claim 1, wherein the step of retrieving the results comprises presenting the results in batches after sorting the table ranks, wherein the table rank is calculated using table weights, the count of the occurrence of a word in a given column and whether the column that contains the words is a primary key column, a foreign key column, or a unique key column.
